(19) United States
(12) Patent Application Publication
(10) Pub. No.: US 2004/0094041 A1
(43) Pub. Date: May 20, 2004

(54) Detachable grill accessory base component

(76) Inventor: John Mark Folkertsma, Ada, MI (US)

Correspondence Address: John Folkertsma, 6878 Rix St., Ada, MI, 49301, US

(21) Appl. No.: 10/702,847

(22) Filed: Nov. 6, 2003

Related U.S. Application Data
(60) Provisional application No. 60/427,026, filed on Nov. 18, 2002.

(51) Int. Cl. A47J 37/04

(52) U.S. Cl. 99/419

(57) ABSTRACT

A barbecue cooking tool component configured so as to be capable of attaching to or detaching from a handle implement. The component includes a clasping mechanism for holding the component between spaced apart rods of a longer handle. In one embodiment, the base component has spaced apart rods which are closer to each other that the spaced apart rods of the handle implement. The spaced apart rods of the base component also have connecting rods on one side and one or more clasping rods on the other side which fit, respectfully, between, over and under hand expanded spaced apart rods of the longer handle implement and attach thereto when the handle's spaced apart rods are released under spring tension to their non-tensioned position. The attachable/detachable base component becomes a component when its parts are augmented and\or added to, to form useful attachable grilling accessories which can be detached for exchangeability on a multipurpose handle, and for easier storage, transportation and cleaning.

### CROSS-REFERENCE TO RELATED APPLICATIONS

This application claims the benefit of PPA Ser. No. 60/427,026, filed Nov. 18, 2002 by the present inventor. The invention in this application can be used with the cooking tongs disclosed in my patent U.S. Pat. No. 6,553,898B2, granted Apr. 29, 2003.

### FEDERALLY SPONSORED RESEARCH

Not Applicable

### SEQUENCE LISTING OR PROGRAM

Not Applicable

### BACKGROUND OF THE INVENTION-FIELD OF INVENTION

This invention relates to barbecue cooking tools and, in particular, to a means of easily attaching various detachable grill accessories such as a skewer or a grill basket to a handle implement, thereby making a versatile, interchangeable barbecue grilling tool.

### BACKGROUND OF THE IVENTION-PRIOR ART

Many grilling accessories such as skewers, general purpose baskets, fish grids and sausage holders, etc., are equipped with permanent handles which tend to be long in order to project away from the heat of the grill. Such implements tend to be cumbersome, take a lot of space for storage and transport, and are especially difficult to clean because they do not fit into kitchen sinks or dishwashers.

Other grilling accessories or prior art may have a means of detaching a food holding implement from a handle but, by design, incorporate a cumbersome attachment/detachment means and not the easy, snap-on means incorporated by this invention, and/or they have a locking mechanism which locks in the food between metal wires or rods during grilling. Additionally, such prior art may comprise a one part handle which can not be separated during grilling. Such restrictions prevent the necessary function to easily and repeatedly separate said wires or rods from the food item during grilling. The resulting inability to easily separate said wires or rods from the food item during the grilling process results in the food sticking to said wires or rods. This results in difficulty in removing the food from said wires or rods after grilling or, in the case of delicate foods, such as soft fleshed fish, the destruction or falling apart of the food item during removal.

With respect to prior art, for instance, U.S. Pat. No. 2,317,388 to S. Lako, Jr., incorporated herein by reference, discloses a one part handle or arm which is permanently attached to a metal cooking grid. The construction of such grid comprises a grid part, which is attached to the extended arm, and to a hinged opposing grid which is locked over a food item during grilling.

Another prior art barbecue tool is shown in U.S. Pat. No. 3,181,453 to E. F. Moran, incorporated herein by reference. As with Lako above, Moran discloses two opposing cooking grids. Said grids are attached by a clasping means on two sides to lock in the food item during grilling. One such grid is attached to a single extended handle or arm which is itself comprised of two parts joined by a separate collar and screw assembly thereby allowing the grids to be detached from the single extended arm or handle. As one of the grids lacks a sufficient extended arm or handle to allow for its control outside the heat zone and also because the clasping means between the grids is not conducive to easy and frequent separation of the grids during grilling, the wires and rods of the two opposing grids cannot be effectively separated from the food during grilling to prevent sticking. Also, while the entire grid assembly is detachable by means of the (collar and screws) connector, the disassembly/re-assembly function is cumbersome and the collar assembly consists of separate parts that can be misplaced.

### BACKGROUND OF THE INVENTION-OBJECTS AND ADVANTAGES

The objects and advantages of the Detachable Grill Accessory Base Component, i.e. the invention, are to provide for a barbecue grilling implement that, unlike prior art, includes all of the following advantages:

a) a detachable handle, which extends beyond the heat, that is attached/detached to a separate accessory in a convenient and easy (snap-on) manner without other parts (such as separate screws and clasps which can be lost) other than the said handle and accessory;

b) a means of such detachability incorporated into any accessory so that they can be attached to the same handle in an interchangeable manner (Note: the handle can comprise one or two implements depending on whether the accessory consists of opposing grid surfaces to hold food between them, or a single skewer which would attach to only one of such handle implements);

c) a means of easily separating an accessory comprising two opposing grids (which hold food between them) during grilling to help prevent food sticking to said grids.

Another object of this invention is to increase the marketing appeal and usefulness by the inventor of his prior invention (Cooking Tongs, U.S. Pat. No. 6,553,898 B2, granted Apr. 29, 2003—J. M. Folkertsma—which is a chargrill grilling implement designed to hold an entire rack of ribs during grilling) by providing a means of attaching/detaching other (handle-less) grilling implements to such Cooking Tongs. It is also an object of this invention, that the said attachment mechanism allows the Cooking Tongs to become a handle to other accessories and helps accomplish the other objectives of the invention without interfering with or in any way complicating the original function of the Cooking Tongs. While the Cooking Tongs are herein referred to in citing the objects of the invention and in the following descriptions and drawings to illustrate the attachment method mechanism, it will become apparent that the cooking tongs are not necessary for the Detachable Grill Accessory Base Component to work and that any extended handle with some basic features as herein described would work.

### SUMMARY OF THE INVENTION

In one embodiment of the invention, a base component is provided, The base component is configured so as to be capable of being securely attached to a pair of spaced apart rods that are attached at their ends by connecting rods, said spaced apart rods forming a multi-purpose handle.

In one embodiment, the base component can be modified by incorporating extensions and attachments which form useful grilling accessories which, when forming a part of said base component, can be securely attached to the multi-purpose handle or Rib Grip.

In one embodiment of the invention, the base component includes spaced apart rods that are attached at their ends by connecting rods, said spaced apart rods being of the same thickness dimension as the spaced apart rods of the multi-purpose handle.

In one embodiment of the invention, the spaced apart rods of the base component are spaced closer to each other than the spaced apart rods of the multi-purpose handle. Therefore, said spaced apart rods of the base component are capable of being placed between the spaced apart rods of the multi-purpose handle.

A feature of the embodiment shown is that the thickness of the spaced apart rods of both the base component and the multi-purpose handle is the same thereby allowing for a clasping mechanism to hold said spaced apart rods in place with respect to each other.

One embodiment of the invention is that the base component includes connecting rods and clasping rods that are attached permanently across its spaced apart rods.

A feature of the end connecting rods of the base component is that they are longer than the distance between the spaced apart rods of the multi-purpose handle thereby preventing the base component from passing through the spaced apart rods of the multipurpose handle when placed between said spaced apart rods.

A feature of the clasping rod(s) is that it\they are placed on the other side of the connecting rods (on the bottom of the base component) and are also longer that the distance between the spaced apart rods of the multi-purpose handle thereby allowing the base component to be firmly held between the spaced apart rods of the multi-purpose handle.

In one embodiment of the invention, the distance between the connecting rods of the multi-purpose handle are far enough apart to provide spring flexibility toward the middle of their spaced apart rods.

A feature of this embodiment is that the spaced apart rods of the handle can be separated under tension and allowed to snap back between the connecting rods and clasping rod of the base component to allow the base component to be firmly held in place between the spaced apart rods of the multi-purpose handle or removed therefrom.

One embodiment of the invention is that the base component can be held in place, forward or backward, within the spaced apart rods of the multi-purpose handle by hand gripping pressure.

In one embodiment of the invention the forward\backward motion of the base component can be further prevented from moving by a locking mechanism, by attaching an additional connecting rod between the spaced apart rods of the multi-purpose handle which is further clasped by a hooking mechanism extending from the base component.

Other features of the invention will become apparent upon reading the description and explanation of the following drawings. The above features should not be read as limiting the scope of the invention which will be defined by claims.

### BRIEF DESCRIPTION OF THE DRAWINGS

FIG. 1 is a perspective view of one embodiment of a base component of the present invention showing the construction of the base component separated from a handle.

FIG. 2 is a perspective view of certain types of a handle which are separate from the base component, but which shows the addition of a connecting rod to which the base component can be locked by inserting hooked ends of the base component under and behind said connecting rod.

FIG. 3 is perspective view showing the base component being inserted into the handle with the hooked ends being inserted under the connecting rod of the handle.

FIG. 4 is a side view of one of the handle implements showing the same thickness of the one appearing spaced apart rod of the handle and the unseen spaced apart rod of the attached base component together with the hooking mechanism, connecting and clasping rods of the base component, and the additional connecting rod of the handle.

FIG. 5 is a perspective view showing connected base components where parts of their structure are augmented and added to, to produce a useful fish, etc., grip implement.

FIG. 6 is a perspective view showing the base component, with parts of its structure being augmented to produce a BBQ skewer, being attached to the handle.

### DETAILED DESCRIPTION OF TH E PREFERED EMODIMENT

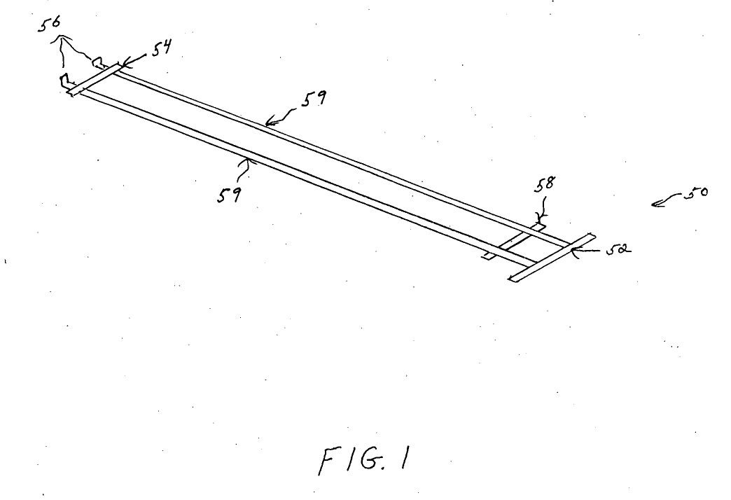

In FIG. 1, the base component is generally indicated as 50. Base component 50 includes two generally parallel and spaced apart rods 59. Spaced apart rods 59 are held apart and connected an their rear surface by connecting rod 52 and on the forward surface by connecting rod 54, Clasping rod 58 is connected on the underside of spaced apart rods 59. Spaced apart rods 59 are hooked up at 56 to provide a locking mechanism.

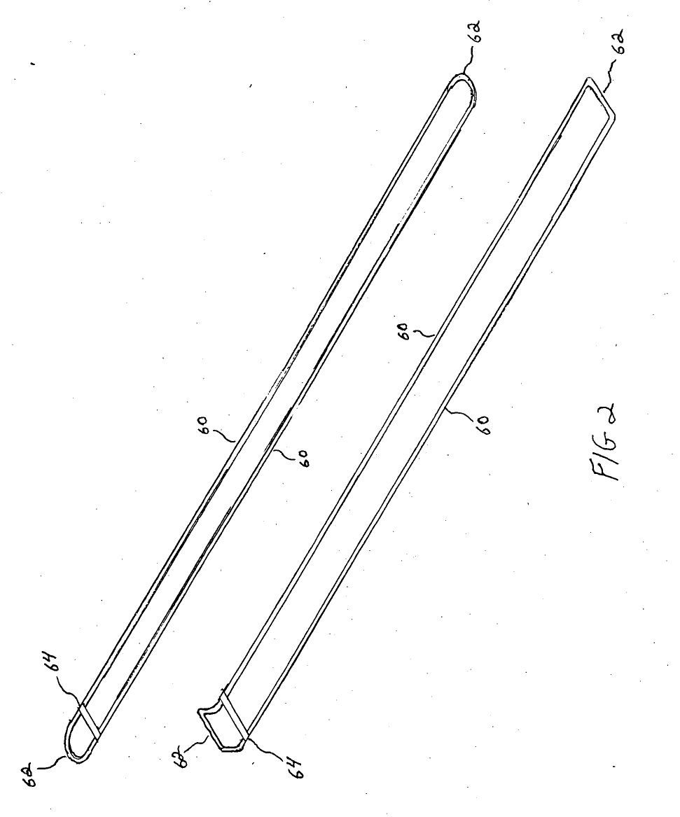

In FIG. 2, the inventors Cooking Tong is portrayed to illustrate handles to which base component 50 can be attached, although and type of handle having spaced apart rods 60, and connecting rods 62 can be attached to base component 50. An extra connecting rod 64 is connected to the surface of spaced apart rods 60.

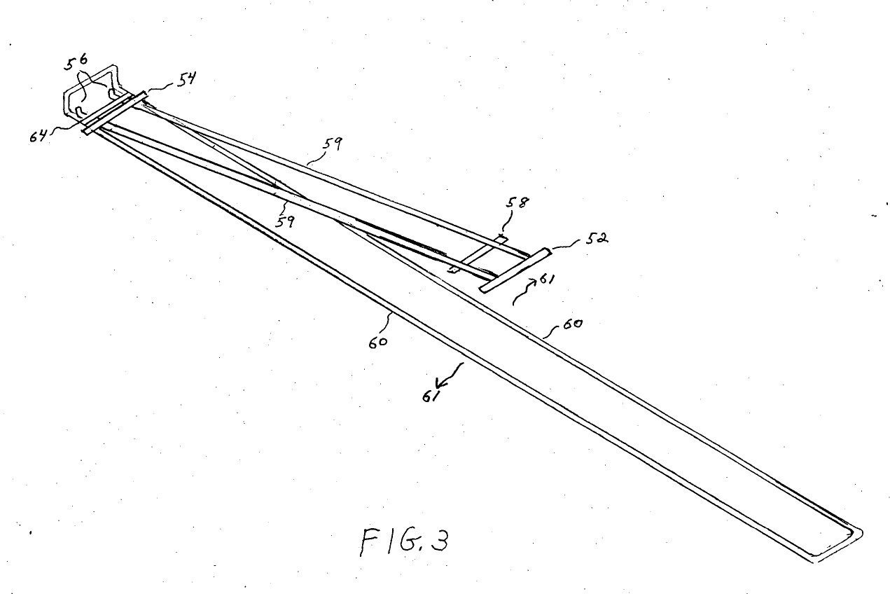

In FIG. 3, base component 50 is shown being inserted into or attached to a handle. The first step in this process is that the hooked ends 56, of the spaced apart rods 59,are inserted under connecting rod 64. Connecting rod 54 extends over spaced apart rods 60 thereby preventing base component 50 from passing all the way through spaced apart rods 60. To complete the attachment, spaced apart rods 60 are bowed outward at 61 by hand thereby allowing clasping rod 58 to pass through to the underside of spaced apart rods 60. The outward bowing pressure of spaced apart rods 60 is released by hand thereby causing clasping rod 58 to clasp the underside of spaced apart rods 60. Connecting rod 52 extends over spaced apart rods 60 thereby preventing base component 50 from passing through spaced apart rods 60. Hooked ends 56 are now fully engaged and prevent base component 50 from moving backward or up from the handle.

The above is the preferred embodiment of the invention, but base component 50 would work almost as well if hooked ends 56 were replaced by a clasping rod like clasping rod 58. Said set of clasping rods, extending past spaced apart rods 60, would hold base component 50 securely between spaced apart rods 60 and rearward motion would be checked by inward hand pressure against spaced apart rods 60; but hooked ends 56 provide a better locking mechanism.

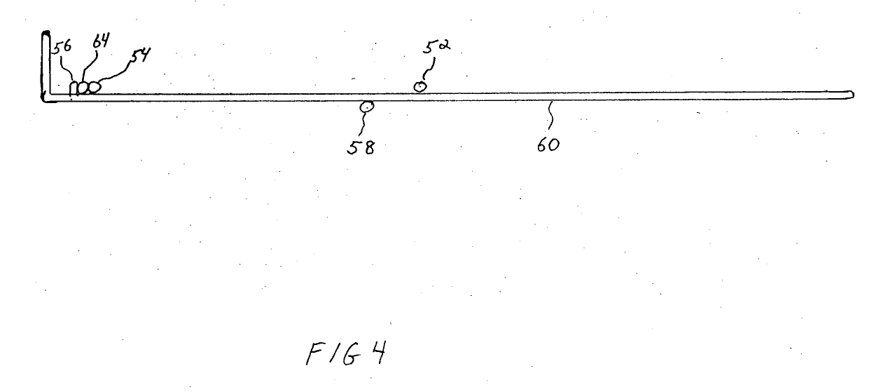

In FIG. 4, base component 50 is attached to spaced apart rods 60. As spaced apart rods 59 are the same thickness of spaced apart rods 60, only spaced apart rods 60 are viewable in this side view. Base component 50 is held within spaced apart rods 60 by connecting rods 52 and 54, and by clasping rod 58. Rearward and forward motion is prevented by connecting rod 64 and hooked ends 56 locking connecting rod 64 therebetween.

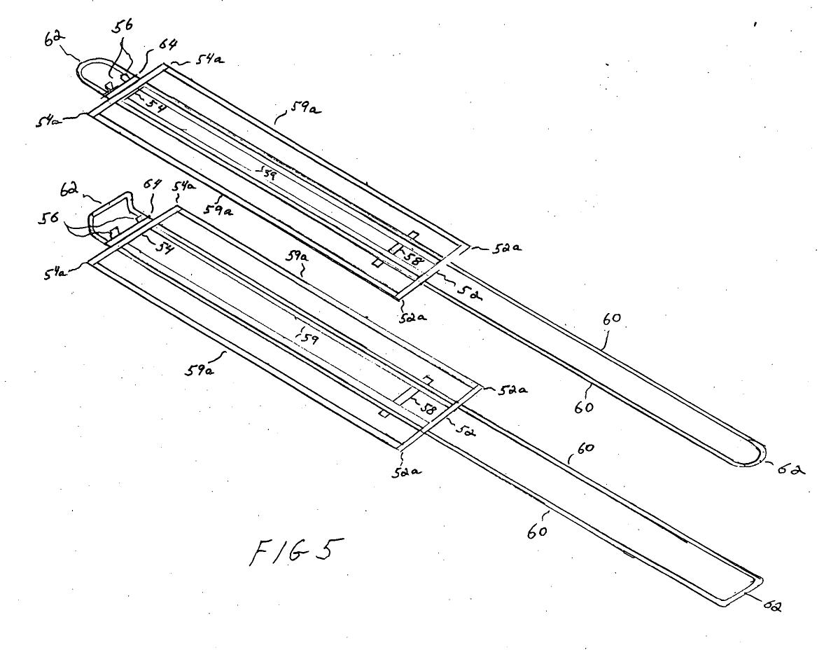

In FIG. 5, the useful application of an attached base component 50 is demonstrated. As noted, connecting rods 52 are lengthened to 52a, and connecting rods 54 are lengthened to 54a. With the attachment of additional spaced apart rods 59a to base component 50, it performs the function of a connected fish grip when the Cooking Tong is engaged as described in US patent application Ser. No. 09\997,187.

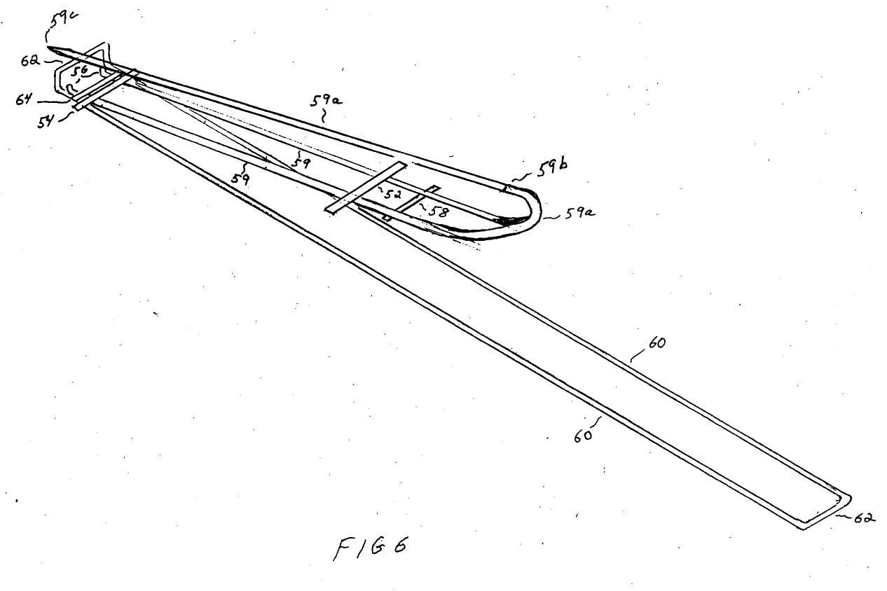

In FIG. 6, another useful application of base component 50 is demonstrated. In this application, the spaced apart rods 59, of base component 50, are elongated past connecting rod 52 and clasping rod 58 to become 59a. One spaced apart rod 59 extends rearward, becoming 59a, and then curves up and around to a strait skewer 59a over the middle of connecting rod 54. The other spaced apart rod 59 is also extended up and around, but is cut off and welded as a support to the other 59a at 59b. Of course, k-bob food items are placed on the skewer prior to connecting base component 50 to spaced apart rods 60. The skewer works especially well with the Rib Grip with the raised end, because the raised end prevents food items from falling off the pointed end 59c when the skewer\base component 50 is fully attached to spaced apart rods 60. It should also be noted that clasping rod 58 is on the other side (or rearward side) of the connecting rod in this application.

As may be apparent, many other grill accessories such as grill baskets, and hamburger holders, etc., can also be attached to a multi-purpose handle through modification of the parts of base component 50 in the type of manner indicated above.

1. A barbecue cooking tool component comprising spaced apart rods, cross connecting rods toward both ends on one surface of the spaced apart rods and one or more cross clasping rods on the other side of the spaced apart rods which fit, respectfully, between, over and under hand expanded spaced apart rods of a longer handle implement and attach thereto when the handle's spaced apart rods are released under spring tension to their non-tensioned position.

2. The barbecue cooking tool component as set forth in claim 1, wherein one or more ends of the spaced apart rods of the component, or rods or other parts added to the component, are hooked to hold against a cross connecting rod on the spaced apart rods of the handle.

3. The barbecue cooking tool component as set forth in claim 1, wherein one or more of said component parts are augmented and\or added to, to form useful attachable\detachable grilling accessories.

4. The barbecue cooking tool component as set forth in claim 2, wherein one or more of said component parts are augmented and\or added to, to form useful attachable\detachable grilling accessories.

5. The barbecue cooking tool component as set forth in claim 1, wherein the spaced apart rods are extended and curved to form one or more skewers which extend under a raised cross connecting rod of a handle for the purpose of attaching or connecting thereto.

6. The barbecue cooking tool component as set forth in claim 2, wherein the spaced apart rods are extended and curved to form one or more skewers which extend under a raised cross connecting rod of a handle for the purpose of attaching or connecting thereto.

7. A barbecue cooking tool component comprising parallel spaced apart rods which are sandwiched between parallel spaced apart rods of a separate handle implement and held thereto by overlapping connecting rods attached on one surface of said parallel spaced apart rods of said barbecue cooking component and one or more overlapping clasping rods attached to the opposite side of said parallel spaced apart rods of said barbecue cooking tool component thereby providing a means of detaching said barbecue cooking tool component from said parallel spaced apart rods of said handle implement by spreading said parallel spaced apart rods of said handle implement out, around and away from said clasping rods and said connecting rods, whereby said barbecue cooking tool component can be made part of a useful accessory that can be attached to a separate multipurpose handle for versatility and ease of cleaning and transport.

8. The barbecue cooking tool component as set forth in claim 7, wherein one or more ends of the parallel spaced apart rods of the component, or rods or other parts added to the component, are hooked to clasp a cross connecting rod on the parallel spaced apart rods of the implement.

9. The barbecue cooking tool component as set forth in claim 7, wherein one or more of said component parts are extended and formed or added to, to create useful attachable/detachable grilling accessories.

10. The barbecue cooking tool component as set forth in claim 8, wherein one or more of said component parts are extended and formed or added to, to create useful attachable/detachable grilling accessories.

11. The barbecue cooking tool component as set forth in claim 7, wherein one or more of the said parallel spaced apart rods are extended and curved around back toward and under a raised cross-connecting rod between the parallel rods of a handle whereby a food skewer is formed onto which food is securely held against forward or backward motion.

12. The barbecue cooking tool component as set forth in claim 8, wherein one or more of the said parallel spaced apart rods are extended and curved around back toward and under a raised cross-connecting rod between the parallel rods of a handle whereby a food skewer is formed onto which food is securely held against forward or backward motion.
